(19) United States
(12) Patent Application Publication
(10) Pub. No.: US 2022/0405920 A1
(43) Pub. Date: Dec. 22, 2022

(54) PORTABLE MEDICAL EDUCATION DEVICE, MEDICAL EDUCATION PLATFORM, AND MEDICAL EDUCATION METHODS

(71) Applicant: NATIONAL YANG MING CHIAO TUNG UNIVERSITY, Taipei (TW)

(72) Inventors: Ding-Han WANG, Tainan City (TW); Chun-Yen LU, Taipei City (TW); Ming-Lun HSU, Taipei City (TW); Yi-Chen HSU, Changhua County (TW); Ngoc Trang TRAN THI, Taipei (TW); Juin-Hong CHERNG, Taipei City (TW); Po-Han WU, Taipei City (TW); Chia-Yu LIN, Taipei City (TW)

(21) Appl. No.: 17/705,778

(22) Filed: Mar. 28, 2022

(30) Foreign Application Priority Data
Jun. 17, 2021 (TW) 110122210

(51) Int. Cl. G06T 7/00; G06V 10/40; G06T 17/00; G09B 5/02

(52) U.S. Cl. CPC G06T 7/0012; G06V 10/40; G06T 17/00; G09B 5/02; G06T 2207/10088; G06T 2207/10081; G06T 2207/30036

(57) ABSTRACT

A portable medical education device, medical education platform, and medical education methods are disclosed. The medical education portable device enables a camera to capture a specific picture to generate an image, extracts several features from the image, converts the features into an identification code, and transmits the identification code to the medical education platform. The medical education platform stores several three-dimensional medical models and finds a specific three-dimensional medical model from the three-dimensional medical models according to the identification code, wherein the preset code corresponding to the specific three-dimensional medical model is the same as the identification code. After that, the medical education platform transmits the specific three-dimensional medical model to the portable medical education device, and the portable medical education device enables a display screen to present a reality scene and enables the reality scene to show the specific three-dimensional medical model.

### CROSS REFERENCE TO RELATED APPLICATIONS

The present invention claims priority under 35 U.S.C. § 119 to Taiwan Patent Application No. 110122210 filed on Jun. 17, 2021, the entire contents of which being incorporated herein by reference.

### FIELD

The present invention relates to portable medical education devices, medical education platforms, and medical education methods. More specifically, the present invention relates to portable medical education devices, medical education platforms, and medical education method that integrates a three-dimensional medical model with a reality scene technology.

### BACKGROUND

In various fields of medical education, it is often the case that the instructor has to explain to the learner(s) about the real condition of various parts of the human body, for example, when it is healthy and/or when it gets a disease by using various three-dimensional medical models (e.g., human organ models, human skeleton models). Conventionally, three-dimensional medical models are drawn by humans, which consume a large amount of time and human-power. As a consequence, it is unmanageable for an instructor to derive sufficient three-dimensional medical models for teaching. Moreover, human-drawn three-dimensional medical models cannot reflect clinical cases in the real world, they are usually inauthentic and subsequently the learner(s) cannot learn the correct medical knowledge. Furthermore, if a course is conducted on-line, the learner can only see, on their own electronic apparatus, a two-dimensional image but not a three-dimensional medical model that contains more specific details, which degrades the learning quality.

As conventional techniques have the aforementioned drawbacks, in order to improve the quality of medical education, there is an urgent need for a technique that allows a learner to derive accurate three-dimensional medical model(s) without having extra equipment.

### SUMMARY

Provided is a portable medical education device. The portable medical education device comprises a camera, a processor, and a communication interface, wherein the processor is electrically connected to the camera and the communication interface. The is configured to generate an image by capturing a specific picture. The processor is configured to extract a plurality of features from the image and convert the features into an identification code. The communication interface is configured to transmit the identification code to a medical education platform so that the medical education platform retrieves a specific three-dimensional medical model corresponding to the identification code. The communication interface is further configured to receive the specific three-dimensional medical model from the medical education platform. The processor is further configured to enable a display screen to render a reality scene and enable the reality scene to render the specific three-dimensional medical model.

Provided is a medical education platform. The medical education platform comprises a storage device, a communication interface, and a processor, wherein the processor is electrically connected to the storage device and the communication interface. The storage device is configured to store a plurality of three-dimensional medical models, wherein each of the three-dimensional medical models corresponds to a predetermined code. The communication interface is configured to receive an identification code from a portable medical education device. The processor is configured to retrieve a specific three-dimensional medical model from the three-dimensional medical models, wherein the predetermined code corresponding to the specific three-dimensional medical model is the same as the identification code. The communication interface is further configured to transmit the specific three-dimensional medical model to the portable medical education device so that the portable medical education device enables a display screen to render the specific three-dimensional medical model.

Provided is a medical education method that can be executed by a portable medical education device. The medical education method comprises the following steps: (a) enabling a camera to generate an image by capturing a specific picture, (b) extracting a plurality of features from the image, (c) converting the features into an identification code, (d) transmitting the identification code to a medical education platform so that the medical education platform retrieves a specific three-dimensional medical model corresponding to the identification code, (e) receiving the specific three-dimensional medical model from the medical education platform, and (f) enabling a display screen to render a reality scene and enabling the reality scene to render the specific three-dimensional medical model.

Provided is a medical education method that can be executed by a medical education platform. The medical education platform stores a plurality of three-dimensional medical models, wherein each of the three-dimensional medical models corresponds to a predetermined code. The medical education method comprises the following steps: (a) receiving an identification code from a portable medical education device, (b) retrieving a specific three-dimensional medical model from the three-dimensional medical models, wherein the predetermined code corresponding to the specific three-dimensional medical model is the same as the identification code, and (c) transmitting the specific three-dimensional medical model to the portable medical education device so that the portable medical education device enables a display screen to render the specific three-dimensional medical model.

The medical education technique provided by the present invention (at a minimum comprises the portable medical education device, medical education platforms, and medical education methods) is realized by having a portable medical education device and a medical education platform work together. The medical education platform stores a plurality of three-dimensional medical models, wherein each of the three-dimensional medical models corresponds to a predetermined code. More specifically, each of the three-dimensional medical models is created by a three-dimensional model construction procedure based on a medical image, hence they are authentic in terms of reflecting real clinic cases. The portable medical education device may generate an image by capturing a specific picture, extract a plurality of features from the image, convert the features into an identification code, receive a specific three-dimensional medical model corresponding to the identification code from the medical education platform, and render the specific three-dimensional medical model in a reality scene shown on a display screen.

With the aforementioned mechanisms, a learner can derive and view a specific three-dimensional medical model corresponding to a specific picture in a reality scene shown on the display screen of their electronic apparatus at hand (e.g., a cell phone, a tablet) by simply capturing the specific picture with the electronic apparatus at hand. Since the specific three-dimensional medical model is created by a three-dimensional model construction procedure based on a real medical image, hence it is authentic in terms of reflecting real clinic cases. Besides, as the specific three-dimensional medical model is rendered in a reality scene, the learner can view and learn the specific three-dimensional medical model from different angles. Thus, the medical education technique provided by the present invention allows a learner to derive accurate three-dimensional medical model(s) without having extra equipment, reducing the cost of medical education, and increasing the quality of medical education.

The detailed technology and preferred embodiments implemented for the subject invention are described in the following paragraphs accompanying the appended drawings for a person having ordinary skill in the art to well appreciate the features of the claimed invention.

### BRIEF DESCRIPTION OF THE DRAWINGS

FIG. 1 illustrates a schematic view of the medical education system 1 in some embodiments of the present invention.

FIG. 2A, FIG. 2B, and FIG. 2C illustrates the concept of rendering the specific three-dimensional medical model MD in a reality scene RS so that the learner can see and learn the specific three-dimensional medical model MD from various angles.

FIG. 3 illustrates the main flowchart of the medical education method 3 in the second embodiment of the present invention.

FIG. 4 illustrates the main flowchart of the medical education method 4 in the third embodiment of the present invention.

FIG. 5 illustrates the main flowchart of the three-dimensional model construction procedure 5.

### DETAILED DESCRIPTION

In the following descriptions, the portable medical education devices, medical education platforms, and medical education methods of the present invention will be explained with reference to certain embodiments thereof. However, these embodiments are not intended to limit the present invention to any specific environment, applications, or implementations described in these embodiments. Therefore, descriptions of these embodiments are for purpose of illustration rather than to limit the scope of the present invention. It should be noted that, in the following embodiments and the attached drawings, elements unrelated to the present invention are omitted from depiction. In addition, dimensions of and dimensional scales between individual elements in the attached drawings are provided only for ease of depiction and illustration but not to limit the scope of the present invention.

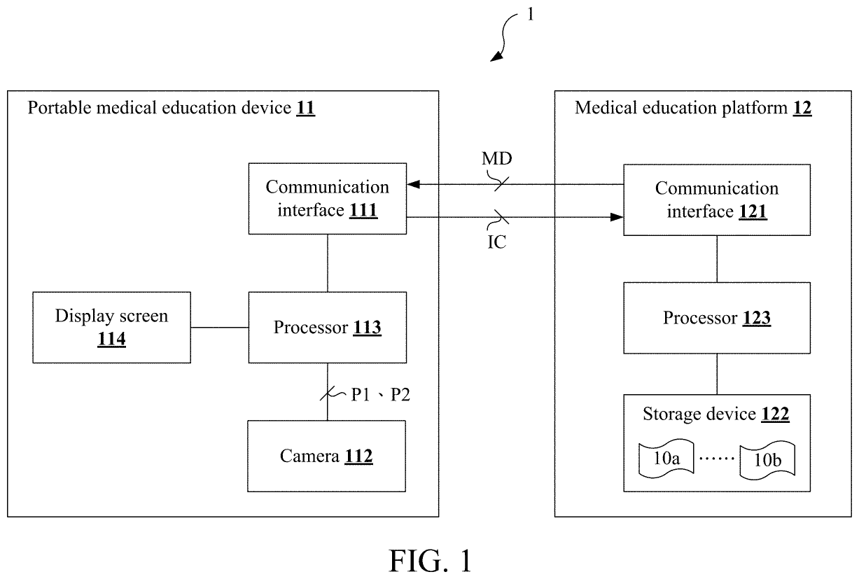

A first embodiment of the present invention is a medical education system 1, and a schematic view of which is illustrated in FIG. 1. The medical education system 1 comprises a portable medical education device 11 and a medical education platform 12. The portable medical education device 11 comprises a communication interface 111, a camera 112, and a processor 113, wherein the processor 113 is electrically connected to the communication interface 111 and the camera 112. In some embodiments, the portable medical education device 11 may further comprise a display screen 114. The portable medical education device 11 may be realized as an electronic computing apparatus that can be carried easily by a user (e.g., a cell phone, a tablet). The medical education platform 12 comprises a communication interface 121, a storage device 122, and a processor 123, wherein the processor 123 is electrically connected to the communication interface 121 and the storage device 122. The medical education platform 12 may be realized by an electronic computing apparatus (e.g., a server, a desktop computer). Please note that the aforementioned “electrically connected” between elements may be “directly electrically connected” (i.e., connected with each other directly without passing any other functional element) or “indirectly electrically connected” (i.e., connected with each other by passing other functional element(s)).

The camera 112 may be built in the portable medical education device 11 or connected to the portable medical education device 11 externally (e.g., mounting on the case of the portable medical education device 11). The camera 112 may be a wireless webcam, a wired webcam, a camera module, or any other element/device that can capture a picture and is known to a person having ordinary skill in the art.

The storage device 122 may be used for storing the data generated and/or received by the medical education platform 12 (e.g., data transmitted to the medical education platform 12 from external devices, data inputted to the medical education platform 12 by users). The storage device 122 may be a Universal Serial Bus (USB) disk, a mobile disk, a Compact Disk (CD), a Digital Versatile Disc (DVD), a Hard Disk Drive (HDD), or any other non-transitory storage medium or apparatus with the same function and known to a person having ordinary skill in the art.

Each of the communication interfaces 111, 121 may be a transceiver, such as an antenna, an amplifier, a modulator, a demodulator, a detector, an analog-to-digital converter, a digital-to-analog converter, etc. The portable medical education device 11 may communicate with and exchange data with external devices via the communication interface 111. Similarly, the medical education platform 12 may communicate with and exchange data with external devices via the communication interface 121. The portable medical education device 11 and the medical education platform 12 may communicate with each other and exchange data with each other directly or indirectly (e.g., via the Internet).

Each of the processors 113, 123 may be one of various processors, Central Processing Units (CPUs), Microprocessors (MPUs), Digital Signal Processors (DSPs), or other computing devices known to a person having ordinary skill in the art.

The portable medical education device 11 and the medical education platform 12 of the medical education system 1 cooperate with each other in order to provide a three-dimensional medical model to a learner for learning. The operations performed by the medical education system 1 will be given in detail in the following description.

The medical education platform 12 plays the role of an instructor or an information provider. The storage device 122 of the medical education platform 12 stores a plurality of three-dimensional medical models 10a, . . . , 10b, wherein each of the three-dimensional medical models 10a, . . . , 10b corresponds to a predetermined code.

In some embodiments, to make the three-dimensional medical models 10a, . . . , 10b authentic in terms of reflecting real clinic cases, each of the three-dimensional medical models 10a, . . . , 10b is created based on a medical image (not shown). To be more specific, the medical education platform 12 may receive a plurality of medical images via the communication interface 121 or another input interface and may store the medical images in the storage device 122. Each of the medical images is a clinical image from any of the various medical fields. For example, each of the medical images may be one of a magnetic resonance image, a computed tomography image, a dental intraoral scan image, and a dental desk scan image. For each of the medical images, the processor 123 may generate a corresponding three-dimensional medical model by performing a three-dimensional model construction procedure.

In some embodiments, the processor 123 may adopt the following three-dimensional model construction procedure. Specifically, the processor 123 may construct an original three-dimensional medical model based on a medical image by a three-dimensional modeling software, such as Materialize Mimics and Blende. For example, the processor 123 may determine the volume of interest by the three-dimensional modeling software so that the three-dimensional modeling software can divide the medical image, perform de-noising, and construct the original three-dimensional medical model based on the divided and de-noised image. The file size of the original three-dimensional medical model generated by the previously mentioned approach is huge, hence the portable medical education device 11 is unable to download and/or render the original three-dimensional medical model. To overcome the aforementioned problem, the processor 123 compresses the original three-dimensional medical model by the three-dimensional modeling software, which results in a polygon-reduced three-dimensional medical model. For example, the processor 123 may generate the polygon-reduced three-dimensional medical model by performing operations such as polygon reduction and image superimposition on the original three-dimensional medical model by the three-dimensional modeling software. After the generation of the polygon-reduced three-dimensional medical model, the processor 123 compares the polygon-reduced three-dimensional medical model with the original three-dimensional medical model. If the difference between the polygon-reduced three-dimensional medical model and the original three-dimensional medical model is within a predetermined range, the processor 123 may assign a predetermined code to the polygon-reduced three-dimensional medical model and store the polygon-reduced three-dimensional medical model in the storage device 122 as a three-dimensional medical model that can be provided to learners. After the medical education platform 12 applies the aforementioned three-dimensional model construction procedure to a plurality of medical images, various three-dimensional medical models 10a, . . . , 10b that can be rendered on a portable medical education device for learning are generated. The three-dimensional medical models 10a, . . . , 10b will be stored in the storage device 122.

In this embodiment, the processor 123 assigns a predetermined code to each of the three-dimensional medical models 10a, . . . , 10b. It is noted that the predetermined codes of the three-dimensional medical models 10a, . . . , 10b are different.

In some embodiments, the user of the medical education platform 12 may assign a specific picture to each of the three-dimensional medical models 10a, . . . , 10b. It is noted that the present invention does not limit the format of each specific picture to any particular format. It is only required that the specific pictures corresponding to the three-dimensional medical models 10a, . . . , 10b are different. For example, each of the specific pictures may be a medical image (e.g., the medical image used for generating the three-dimensional medical model, a similar medical image) or a QR code. For each of the three-dimensional medical models 10a, . . . , 10b, the processor 123 extracts a plurality of features from the corresponding specific picture and then generates the predetermined code based on the features. It is noted that the present invention does not limit the way for extracting the features from a specific picture to any particular way. For example, the processor 123 may utilize a feature extraction technique to extract the features from a specific picture, and the feature extraction technique may be an algorithm for performing Scale-Invariant Feature Transform (SIFT), an algorithm for performing Speeded Up Robust Features (SURF), an algorithm for performing Histogram of Oriented Gradient (HOG), or any other feature extraction algorithm that is known by a person having ordinary skill in the art. It is also noted that the present invention does not limit the way for generating a predetermined code based on the features of a specific picture.

In the following description, the way that a learner uses the portable medical education device 11 to derive a three-dimensional medical model for learning will be given in detail.

The learner may use the camera 112 of the portable medical education device 11 to shoot/capture a specific picture and then derives a first image P1. The specific picture shot/captured by the camera 112 is one of the specific pictures that the medical education platform 12 assigned to the three-dimensional medical models 10a, . . . , 10b. Please note that the present invention does not have any restriction on the place for showing the specific picture to be shot/captured by a camera. For example, the specific picture to be shot/captured by a camera can be shown on a slide, a display screen of a local electronic apparatus that a learner is watching, or a paper-based learning material that a learner gets.

Then, the processor 113 of the portable medical education device 11 extracts a plurality of first features from the first image P1. Similarly, the present invention does not limit the way for extracting the first features from the first image P1 to any specific way. In some embodiments, the processor 113 may utilize a feature extraction technique to extract the first features from the first image P1, and the feature extraction technique may be an algorithm for performing SIFT, an algorithm for performing SURF, an algorithm for performing HOG, or any other feature extraction algorithm that is known by a person having ordinary skill in the art.

After extracting the first features from the first image P1, the processor 113 converts the first features into an identification code IC. It is noted that the way that the processor 113 converts the features of an image into an identification code is the same as the way that the processor 123 of the medical education platform 12 converts the features of a specific picture into a predetermined code. In some embodiments, the portable medical education device 11 may further comprise a storage device (not shown) for storing a mapping between the identification code IC and the first features. For those embodiments, every time that the camera 112 generates an image by capturing a specific picture and the processor 113 extracts a plurality of features from the image, the processor 113 determines whether the storage already has a corresponding identification code according to one or more mappings in the storage device. If the camera 112 generates a second image P2 by capturing the same specific picture again, a plurality of second features extracted from the second image P2 will be the same as the first features stored in the storage device. Then, the processor 113 may determine that the second features also correspond to the identification code IC according to the second features and the mapping between the identification code and the first features. By storing the mapping between the identification code and the features of an image, the operation time required by the processor 113 for generating the identification code can be reduced (i.e., the procedure for generating the identification code is sped up) when the camera 112 captures the same specific picture.

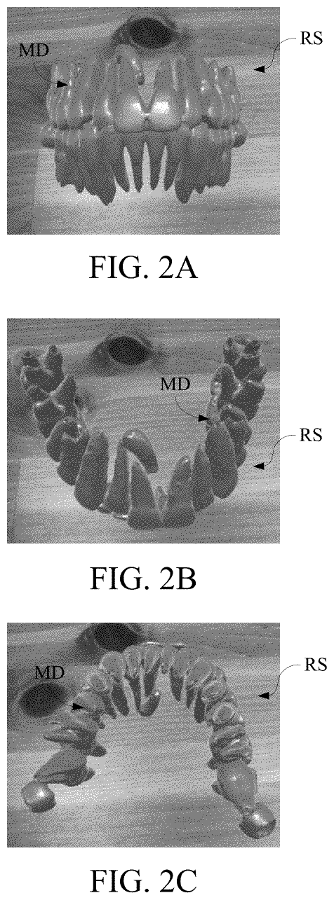

Next, the processor 113 transmits the identification code IC to the medical education platform 12 via the communication interface 111. After the medical education platform 12 receives the identification code IC from the portable medical education device 11 via the communication interface 121, the processor 123 retrieve a specific three-dimensional medical model MD from the three-dimensional medical models 10a, . . . , 10b. The predetermined code corresponding to the specific three-dimensional medical model MD is the same as the identification code IC. The communication interface 121 of the medical education platform 12 transmits the specific three-dimensional medical model MD to the portable medical education device 11. The communication interface 111 of the portable medical education device 11 receives the specific three-dimensional medical model MD from the medical education platform 12. Afterwards, the processor 113 of the portable medical education device 11 enables the display screen 114 to render a reality scene RS and enables the reality scene RS to render the specific three-dimensional medical model MD. Since the specific three-dimensional medical model MD is rendered in the reality scene RS, the learner can see and learn the specific three-dimensional medical model MD from various angles as shown in FIG. 2A to FIG. 2C.

The previously mentioned reality scene RS may be a virtual environment, a virtual-physical integration environment, or a virtual-physical mixture environment constructed by a reality technology. For example, the previously mentioned reality scene RS may be a Virtual Reality (VR) scene, an Augmented Reality (AR) scene, a Mixed Reality (MR) scene, and a Cinematic Reality (CR) scene.

In some embodiments, the learner may need to select an application program on the portable medical education device 11 and then enable the processor 113 to execute the application program in order to make the portable medical education device 11 performs the previously mentioned operations. For those embodiments, the portable medical education device 11 may further comprise a storage device for storing the specific three-dimensional medical model MD temporarily when the processor 113 executes the application program. In this way, during the procedure that the processor 113 executes the application program, the display screen 114 can continuously render the specific three-dimensional medical model MD in the reality scene RS to keep the learner learning even if the communication connection between the portable medical education device 11 and the medical education platform 12 fails.

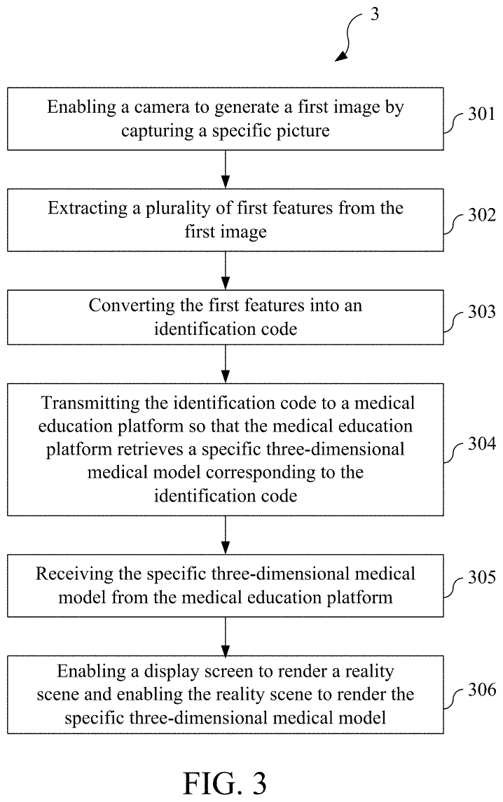

A second embodiment of the present invention is a medical education method 3 for use in a portable medical education device (e.g., the previously mentioned portable medical education device 11), and the main flowchart is illustrated in FIG. 3. In this embodiment, the medical education method 3 comprises step 301 to step 306.

In step 301, the portable medical education device enables a camera to generate a first image by capturing a specific picture. In step 302, the portable medical education device extracts a plurality of first features from the first image. In step 303, the portable medical education device converts the first features into an identification code. In step 304, the portable medical education device transmits the identification code to a medical education platform so that the medical education platform retrieves a specific three-dimensional medical model corresponding to the identification code. In step 305, the portable medical education device receives the specific three-dimensional medical model from the medical education platform. In step 306, the portable medical education device enables a display screen to render a reality scene and enables the reality scene to render the specific three-dimensional medical model.

In some embodiments, after executing step 303, the medical education method 3 may further comprise another step, in which the portable medical education device stores a mapping between the identification code and the first features. For those embodiments, the medical education method 3 may have the portable medical education device to execute the following steps: enabling the camera to generate a second image by capturing the specific picture again, extracting a plurality of second features from the second image, determining that the second features correspond to the identification code, transmitting the identification code to the medical education platform, receiving the specific three-dimensional medical model from the medical education platform, and enabling the display screen to render the specific three-dimensional medical model. Briefly speaking, by storing the mapping between the identification code and the features, the time for generating the identification code may be shortened if the portable medical education device captures the same specific picture again.

In some embodiments, the medical education method 3 may have the portable medical education device to execute another step for executing an application program to render the reality scene and another step for storing the specific three-dimensional medical model temporarily when the processor executes the application program. In this way, the display screen of the portable medical education device can continuously render the specific three-dimensional medical model in the reality scene to keep the learner learning even if the communication connection between the portable medical education device and the medical education platform fails.

In addition to the previously mentioned steps, the medical education method 3 can also execute all the operations and steps that can be executed by the portable medical education device 11 in the aforementioned embodiments, have the same functions as the previously mentioned portable medical education device 11, and deliver the same technical effects as the previously mentioned the portable medical education device 11. How the medical education method 3 executes these operations and steps, has the same functions, and delivers the same technical effects as the portable medical education device 11 will be readily appreciated by a person having ordinary skill in the art based on the above explanation of the portable medical education device 11, and thus will not be further described herein.

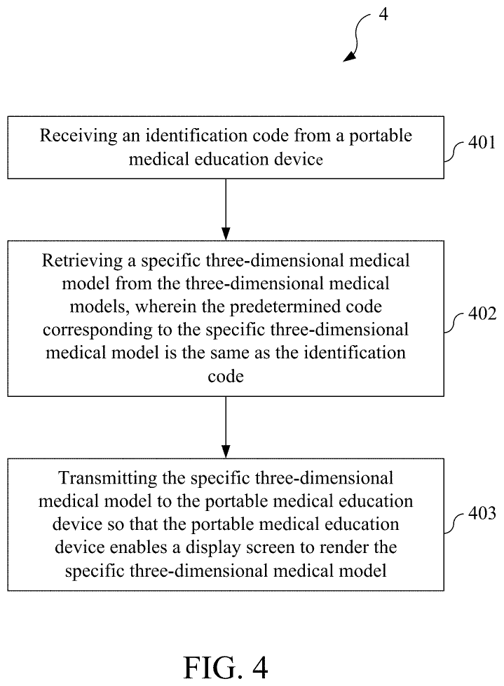

A third embodiment of the present invention is a medical education method 4 for use in a medical education platform (e.g., the previously mentioned medical education platform 12), and the main flowchart is illustrated in FIG. 4. The medical education platform stores a plurality of three-dimensional medical models, wherein each of the three-dimensional medical models corresponds to a predetermined code. In this embodiment, the medical education method 4 comprises step 401 to step 403.

In step 401, the medical education platform receives an identification code from a portable medical education device. In step 402, the medical education platform retrieves a specific three-dimensional medical model from the three-dimensional medical models, wherein the predetermined code corresponding to the specific three-dimensional medical model is the same as the identification code. In step 403, the medical education platform transmits the specific three-dimensional medical model to the portable medical education device so that the portable medical education device enables a display screen to render the specific three-dimensional medical model.

In some embodiments, if the medical education platform has not stored a plurality of three-dimensional medical models yet, the medical education method 4 may have the medical education platform to execute another step for generating a three-dimensional medical model by performing a three-dimensional model construction procedure based on a medical image. If there is more than one medical image, the medical education method 4 may apply the three-dimensional model construction procedure to each of the medical images so as to derive a plurality of three-dimensional medical models. Each of the medical images is a clinical image from any of the various medical fields. For example, each of the medical images may be one of a magnetic resonance image, a computed tomography image, a dental intraoral scan image, and a dental desk scan image.

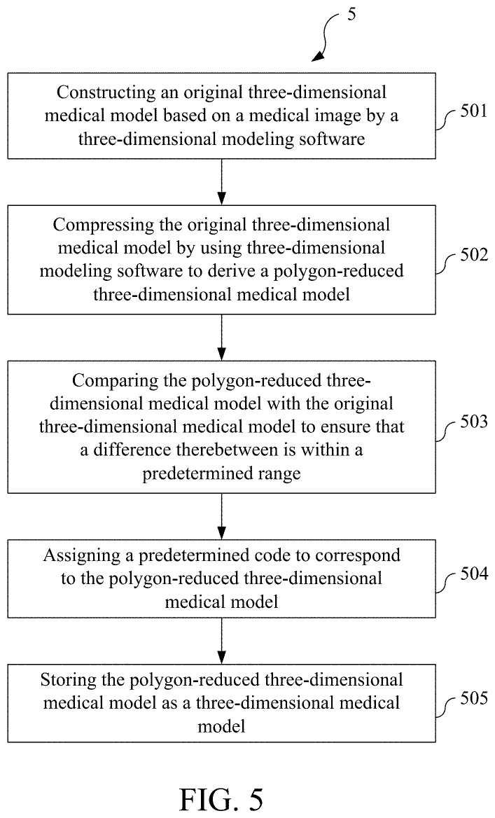

In some embodiments, the previously mentioned three-dimensional model construction procedure 5 may comprise the steps shown in FIG. 5. In step 501, the medical education platform constructs an original three-dimensional medical model based on a medical image by three-dimensional modeling software. In step 502, the medical education platform compresses the original three-dimensional medical model using three-dimensional modeling software, which results in a polygon-reduced three-dimensional medical model. In step 503, the medical education platform compares the polygon-reduced three-dimensional medical model with the original three-dimensional medical model to ensure that a difference therebetween is within a predetermined range. In step 504, the medical education platform assigns a predetermined code to correspond to the polygon-reduced three-dimensional medical model. In step 505, the medical education platform stores the polygon-reduced three-dimensional medical model as a three-dimensional medical model.

In addition to the previously mentioned steps, the medical education method 4 can also execute all the operations and steps that can be executed by the previously mentioned medical education platform 12 in the aforementioned embodiments, have the same functions as the previously mentioned medical education platform 12, and deliver the same technical effects as the previously mentioned the aforesaid medical education platform 12. How the medical education method 4 executes these operations and steps, has the same functions, and delivers the same technical effects as the medical education platform 12 will be readily appreciated by a person having ordinary skill in the art based on the above explanation of the medical education platform 12, and thus will not be further described herein.

It shall be noted that, in the specification and the claims of the present invention, some words (including images and features) are preceded by terms such as “first” or “second,” and these terms of “first” and “second” are used to distinguish these words from each other.

According to the above descriptions, the medical education technique provided by the present invention (at least comprises the portable medical education device, medical education platforms, and medical education methods) is realized by having a portable medical education device and a medical education platform work together. The medical education platform stores a plurality of three-dimensional medical models, wherein each of the three-dimensional medical models corresponds to a predetermined code. Each of the three-dimensional medical models is created by a three-dimensional model construction procedure based on a real medical image, hence they are authentic in terms of reflecting real clinic cases. The portable medical education device may generate an image by capturing a specific picture, extract a plurality of features from the image, convert the features into an identification code, receive a specific three-dimensional medical model corresponding to the identification code from the medical education platform, and render the specific three-dimensional medical model in a reality scene shown on a display screen.

With the aforementioned mechanisms, a learner can derive and view a specific three-dimensional medical model corresponding to a specific picture in a reality scene shown on the display screen of his or her electronic apparatus at hand (e.g., a cell phone, a tablet) by simply shooting the specific picture by the electronic apparatus at hand. Since the specific three-dimensional medical model is created by a three-dimensional model construction procedure based on a real medical image, hence it is authentic in terms of reflecting real clinic cases. Besides, as the specific three-dimensional medical model is rendered in a reality scene, the learner can view and learn the specific three-dimensional medical model from different angles. Thus, the medical education technique provided by the present invention allows a learner to derive accurate three-dimensional medical model(s) without having extra equipment, reducing the cost of medical education, and increasing the quality of medical education.

The above disclosure is related to the detailed technical contents and inventive features thereof. A person having ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have been covered in the following claims as appended.

What is claimed is:

1. A portable medical education device, comprising:
a camera, being configured to generate a first image by capturing a specific picture;
a processor, being electrically connected to the camera and being configured to extract a plurality of first features from the first image and convert the first features into an identification code; and
a communication interface, being electrically connected to the processor and being configured to transmit the identification code to a medical education platform so that the medical education platform retrieves a specific three-dimensional medical model corresponding to the identification code,
wherein the communication interface further receives the specific three-dimensional medical model from the medical education platform, and the processor further enables a display screen to render a reality scene and enables the reality scene to render the specific three-dimensional medical model.

2. The portable medical education device of claim 1, further comprising:
a storage device, being electrically connected to the processor and being configured to store a mapping between the identification code and the first features.

3. The portable medical education device of claim 2, wherein the camera further generates a second image by capturing the specific picture again, the processor further extracts a plurality of second features from the second image and determines that the second features correspond to the identification code, the communication interface further transmits the identification code to the medical education platform and receives the specific three-dimensional medical model from the medical education platform, and the processor further enables the display screen to render the specific three-dimensional medical model.

4. The portable medical education device of claim 1, wherein the processor further executes an application program to render the reality scene, and the portable medical education device further comprises:
a storage device, being configured to store the specific three-dimensional medical model temporarily when the processor executes the application program.

5. A medical education platform, comprising:
a storage device, being configured to store a plurality of three-dimensional medical models, wherein each of the three-dimensional medical models corresponds to a predetermined code;
a communication interface, being configured to receive an identification code from a portable medical education device; and
a processor, being electrically connected to the storage device and the communication interface and being configured to retrieve a specific three-dimensional medical model from the three-dimensional medical models, wherein the predetermined code corresponding to the specific three-dimensional medical model is the same as the identification code,
wherein the communication interface further transmits the specific three-dimensional medical model to the portable medical education device so that the portable medical education device enables a display screen to render the specific three-dimensional medical model.

6. The medical education platform of claim 5, wherein the storage device further stores a medical image, and the processor further generates the specific three-dimensional medical model by performing a three-dimensional model construction procedure based on the medical image.

7. The medical education platform of claim 6, wherein the medical image is one of a magnetic resonance image, a computed tomography image, a dental intraoral scan image, and a dental desk scan image.

8. A medical education method, being executed by a portable medical education device comprising the following steps:
enabling a camera to generate a first image by capturing a specific picture;
extracting a plurality of first features from the first image;
converting the first features into an identification code;
transmitting the identification code to a medical education platform so that the medical education platform retrieves a specific three-dimensional medical model corresponding to the identification code;
receiving the specific three-dimensional medical model from the medical education platform; and
enabling a display screen to render a reality scene and enabling the reality scene to render the specific three-dimensional medical model.

9. The medical education method of claim 8, further comprising the following step:
storing a mapping between the identification code and the first features.

10. The medical education method of claim 9, further comprising the following steps:
enabling the camera to generate a second image by capturing the specific picture again;
extracting a plurality of second features from the second image;
determining that the second features correspond to the identification code;
transmitting the identification code to the medical education platform;
receiving the specific three-dimensional medical model from the medical education platform; and
enabling the display screen to render the specific three-dimensional medical model.

11. The medical education method of claim 8, further comprising the following steps:
executing an application program to render the reality scene; and
storing the specific three-dimensional medical model temporarily when the processor executes the application program.

12. A medical education method, being executed by a medical education platform, the medical education platform storing a plurality of three-dimensional medical models, each of the three-dimensional medical models corresponding to a predetermined code, and the medical education method comprising the following steps:
receiving an identification code from a portable medical education device;
retrieving a specific three-dimensional medical model from the three-dimensional medical models, wherein the predetermined code corresponding to the specific three-dimensional medical model is the same as the identification code; and
transmitting the specific three-dimensional medical model to the portable medical education device so that the portable medical education device enables a display screen to render the specific three-dimensional medical model.

13. The medical education method of claim 12, further comprising the following step:
generating the specific three-dimensional medical model by performing a three-dimensional model construction procedure based on a medical image.

14. The medical education method of claim 13, wherein the medical image is one of a magnetic resonance image, a computed tomography image, a dental intraoral scan image, and a dental desk scan image.
